(19) United States
(12) Patent Application Publication
(10) Pub. No.: US 2024/0117198 A1
(43) Pub. Date: Apr. 11, 2024

(54) RADIATION-CURABLE SILICONE COMPOSITION COMPRISING A RELEASE CONTROL ADDITIVE

(71) Applicant: ELKEM SILICONES FRANCE SAS, LYON (FR)

(72) Inventors: Christian MALIVERNEY, SAINT JULIEN SUR BIBOST (FR); Perrine THEIL, SAINT-PIERRE DE CHANDIEU (FR); Stéphanie BENITOU, SAINT CYR SUR LE RHÔNE (FR); Mélanie FALZONE, FARNAY (FR)

(21) Appl. No.: 18/270,291

(22) PCT Filed: Jan. 7, 2022
(86) PCT No.: PCT/FR2022/050038

§ 371 Date: Jun. 29, 2023

(30) Foreign Application Priority Data
Jan. 8, 2021 (FR) 2100176

(51) Int. Cl. C09D 5/16; C08G 77/16; C08G 77/20; C08G 77/442; C09D 183/10

(52) U.S. Cl. CPC C09D 5/1675; C08G 77/16; C08G 77/20; C08G 77/442; C09D 183/10; C08G 77/70

(57) ABSTRACT

The present invention relates to a photo-curable silicone composition comprising a release control additive which is an organopolysiloxane resin comprising Si—OH groups. In particular, the invention relates to a silicone composition comprising at least one organopolysiloxane A including at least one (meth)acrylate group, at least 25% by weight of an organopolysiloxane resin B comprising Si—OH groups, and at least one radical photoinitiator C. The compositions of the invention can be used to form release coatings.

### TECHNICAL FIELD

The present invention relates to a radiation-curable silicone composition comprising a release control additive which is an organopolysiloxane resin comprising Si—OH groups. In particular, the invention relates to a silicone composition comprising at least one organopolysiloxane A including at least one (meth)acrylate group, at least 25% by weight of an organopolysiloxane resin B comprising Si—OH groups, and, optionally, at least one radical photoinitiator C. The compositions of the present invention can be used to form release coatings.

### TECHNOLOGICAL BACKGROUND

The use of plastic films as substrate materials for the application of silicone coatings in order to create release coatings (non-stick coatings) requires an appropriate technology. Indeed, most of these plastic films are heat-sensitive. A dimensional deformation of the film thus occurs during the coating and drying of the silicone layer in thermal ovens under the combined effect of the tensile forces and of the temperature to which the films are subjected. The technology of curing functional silicone oils under irradiation, in particular under ultraviolet (UV) radiation, makes it possible to dispense with the use of high temperatures and therefore to crosslink the release layers without impacting the substrates. In addition, this technology has the advantage of achieving high productivity without being energy-intensive and without the use of solvents. Plastic substrates are the materials of choice for many applications, and their use is constantly growing.

The preparation of silicone release coatings is generally carried out as follows: a silicone composition is applied to a substrate in an industrial coating device comprising rollers operating at very high speed (for example 600 m/min). Once applied to the substrate, the silicone composition is cured to form a solid silicone (e.g. elastomer) release coating. The coated substrate obtained is also called a silicone liner. This silicone liner can in particular be laminated with an adhesive, because the silicone release coating makes it possible to facilitate the removal of adhesive materials reversibly bonded onto these substrates. Thus, these silicone liners can be used in the field of self-adhering labels, strips including envelopes, graphic arts, medical care and hygiene.

The silicone compositions used to form release coatings are generally cured (crosslinked) under irradiation, in particular under UV or visible radiation emitted by doped or undoped mercury vapor lamps whose emission spectrum extends from 200 nm to 450 nm. Light sources such as light-emitting diodes, better known by the acronym “LED”, which deliver spot UV or visible light can also be used.

The radiation curing of functionalized silicone oils can be done according to two approaches: cationic polymerization of epoxy groups or free-radical polymerization of acrylic functional groups. Free-radical polymerization is inhibited neither by bases nor by humidity. The coating substrates and additives can thus be more diversified, and interest in such radical systems is growing.

Free-radical polymerization of molecules with acrylic functional groups under irradiation, in particular under UV irradiation, is well documented. The same is true for silicone oils with acrylic functional groups which have been prepared according to various routes. One of the most important characteristics of these silicone acrylate compositions is controlling the adhesion of cured silicone compositions to an adhesive according to the intended use and in particular according to the substrate material used. Thus, various compositions which enable controlling adhesion to an adhesive according to the desired level have been developed for radiation-cured silicone acrylates.

For example, document FR2632960 describes polysiloxanes with (meth)acrylic ester groups linked by SiC groups. By adjusting the chain lengths and the acrylate levels of the polysiloxane oils, it is possible to control the adhesion of these UV-cured systems. However, with this approach it is necessary to synthesize a new siloxane oil for each targeted level of release, making the possibility of adjustment difficult.

It is therefore necessary to develop silicone acrylate compositions which allow easily controlling the level of release relative to an adhesive, for the coating obtained after curing the silicone composition, according to the intended application.

In this context, the present invention aims to satisfy at least one of the following objectives.

One of the essential objectives of the invention is to provide a radiation-curable silicone composition comprising a release control additive (“RCA”) and which can be used to form release coatings.

Another essential object of the invention is to provide a radiation-curable silicone composition having improved properties.

Another essential objective of the invention is to provide a radiation-curable silicone composition whose properties of adhesion, relative to an adhesive, of the coating obtained after curing the silicone composition can be controlled.

Another essential objective of the invention is to provide a radiation-curable silicone composition which is easy to prepare industrially and is economical.

Another essential objective of the invention is to provide a radiation-curable silicone composition which can be used without a solvent, for ecological concerns.

Another essential objective of the invention is to provide a radiation-curable silicone composition having a viscosity compatible with the coating tools used to prepare silicone release coatings.

Another essential objective of the invention is to provide a radiation-curable silicone composition which allows obtaining a coating having a “smooth” release profile, meaning with little or no noise when pulling, i.e. the release forces remain stable throughout the step of delaminating the complex (separating the adhesive and the silicone liner).

Another essential objective of the invention is to provide a radiation-curable silicone composition which allows obtaining a coating having release forces which remain stable with aging.

Another essential objective of the invention is to provide a radiation-curable silicone composition which allows obtaining a coating having release forces that are stable at any peeling speed.

### BRIEF DESCRIPTION OF THE INVENTION

These objectives, among others, are achieved by the present invention which firstly relates to a radiation-curable silicone composition X comprising:
a. at least one organopolysiloxane A including at least one (meth)acrylate group;
b. at least 25% by weight of an organopolysiloxane resin B comprising Si—OH groups; and
c. optionally, at least one radical photoinitiator C.

The fact of using at least 25% by weight of an organopolysiloxane resin B comprising Si—OH groups makes it possible to control the adhesion of the coating obtained after curing the silicone composition X, relative to an adhesive. It is therefore possible to use the radiation-cured silicone composition X to form release coatings on a substrate. The non-adhesion of the free outer face of the silicone coating is expressed through release forces from a standardized adhesive, these being verified. The release forces can in particular be measured by the FINAT 3 (FTM 3) test, well known to those skilled in the art. This test allows determining the release forces (also called peeling force) necessary to peel apart the coated substrate (also called silicone liner) laminated with an adhesive. The compositions according to the invention make it possible to easily control these release forces, and therefore the release properties relative to an adhesive, according to the intended application, in particular by adjusting the level of resin in the composition.

Furthermore, the coatings obtained after curing the compositions of the invention have a release profile which is “smooth”, the release forces remaining stable throughout the step of delaminating the complex (separating the adhesive and the silicone liner). In addition, these advantages are obtained while maintaining good properties elsewhere (smear, rub-off, and subsequent adhesion).

The invention also relates to the use of the radiation-curable silicone composition X for the preparation of silicone elastomers that can be used as a release coating on a substrate.

The invention also relates to a method for preparing a coating on a substrate, comprising the following steps:
applying a radiation-curable silicone composition X, and
curing said composition by electron or photon irradiation, preferably by exposure to an electron beam, by exposure to gamma rays, or by exposure to radiation having a wavelength of between 200 nm and 450 nm, in particular UV radiation.

The substrates which can be coated are, for example, flexible substrates made of textile, paper, polyvinyl chloride, polyester, polypropylene, polyamide, polyethylene, polyethylene terephthalate, polyurethane, or non-woven glass fibers.

The invention also relates to a coated substrate obtainable by the method described above.

The invention also relates to a premix for a silicone composition, comprising:
a. between 20 and 40% by weight of at least one organopolysiloxane A including at least one (meth)acrylate group;
b. between 30 and 50% by weight of an organopolysiloxane resin B comprising Si—OH groups; and
c. between 10 and 30% by weight of an organic compound D comprising a (meth)acrylate functional group.

### Definitions

In the present application, the term “radiation-curable silicone composition” is understood to mean a silicone composition comprising at least one organopolysiloxane capable of crosslinking by electronic or photonic irradiation. The electronic irradiations include an electron beam. The photonic irradiations include exposure to radiation having a wavelength of between 200 nm and 450 nm, in particular UV radiation, or exposure to gamma rays.

“Release control additive” is understood to mean an adhesion control agent capable of modifying the adhesion or release properties of the coating obtained after curing the silicone composition X, relative to an adhesive.

Throughout this document, organopolysiloxanes will be conventionally described using the usual notation in which the letters M, D, T and Q are used to designate various siloxyl units. As a reference work, mention can be made of NOLL “Chemistry and technology of silicones”, chapter 1.1, pp. 1-9, Academic Press, 1968
2nd edition. In this notation, the silicon atom of a siloxyl unit is engaged in one (M), two (D), three (T), or four (Q) covalent bonds with as many oxygen atoms. When an oxygen atom is shared between two silicon atoms, it is counted as ½ and it will not be mentioned in an abbreviated formula. However, if the oxygen atom belongs to a hydroxyl group bonded to a silicon atom, this chemical functional group may be indicated in parentheses in the abbreviated formula. By default, the remaining bonds of the silicon atom are considered to be engaged with a carbon atom. Generally, hydrocarbon groups linked to silicon by a C—Si bond are not mentioned and most often correspond to an alkyl group, for example a methyl group. For example, the abbreviated formula T(OH)₂ represents a unit in which the silicon atom is bonded to three oxygen atoms including two hydroxyl groups, i.e. an alkyldihydroxysiloxyl unit RSi(OH)₂O_{1/2} where R can represent various saturated or unsaturated hydrocarbon groups, in particular aromatic, and possibly substituted by heteroatoms. The meaning of R will be specified in the description.

“(Meth)acrylate” is understood to mean a methacrylate group or an acrylate group.

“Organopolysiloxane resin” is understood to mean an organopolysiloxane compound comprising at least one T unit and/or at least one Q unit.

“Alkylene” is understood to mean a divalent, linear or branched alkyl group. The alkylene group preferably comprises between 1 and 18 carbon atoms, and more preferably between 1 and 12 carbon atoms.

“Heteroalkylene” is understood to mean a divalent, linear or branched heteroalkyl group. The heteroalkyl group preferably comprises between 1 and 18 carbon atoms, and between 1 and 6 heteroatoms selected from the group composed of O, N, and S, where N and S can optionally be oxidized. The heteroatoms can be placed at any position in the heteroalkyl group, in the interior position or at one end.

“Cycloalkylene” is understood to mean a divalent cycloalkyl. The cycloalkyl group preferably comprises between 3 and 12 carbon atoms, preferably between 3 and 6 carbon atoms.

“Solvent” is understood to mean an organic solvent. Organic solvents are well known to those skilled in the art. Examples of organic solvents include alkanes (such as pentane or hexane), aromatics (such as benzene, toluene, or xylene), ethers (such as diethyl ether or tetrahydrofuran), alcohols (such as methanol, ethanol, propanol, or butanol), chloroform, acetone, acetonitrile, pyridine, ethyl acetate, dimethylformamide, and dimethyl sulfoxide. “Solventless composition” is understood to mean a composition comprising less than 10% by weight of solvent, preferably less than 5%, and more preferably less than 1%.

In this application, all percentages are indicated in % by weight, unless otherwise stated.

### DETAILED DESCRIPTION

The radiation-curable silicone composition X comprises:
a. at least one organopolysiloxane A including at least one (meth)acrylate group;
b. at least 25% by weight of an organopolysiloxane resin B comprising Si—OH groups; and
c. optionally, at least one radical photoinitiator C.

According to one embodiment, the silicone composition X is curable by electron or photon irradiation, preferably by exposure to an electron beam, by exposure to gamma rays, or by exposure to radiation having a wavelength of between 200 nm and 450 nm, in particular UV radiation.

It is possible to use this radiation-curable silicone composition X as is, without needing to dilute it in a solvent. Thus, according to one embodiment, the radiation-curable silicone composition X is solventless.

The radiation-curable silicone composition X can have a viscosity of between 200 and 2500 mPa·s, preferably between 500 and 1500 mPa·s; it is therefore possible to use it with the coating tools used for preparing silicone release coatings.

All the viscosities referred to in the present description correspond to a magnitude of dynamic viscosity at 25° C. referred to as “Newtonian”, meaning the dynamic viscosity which is measured, in a manner known per se, using a Brookfield viscometer at a sufficiently low shear rate gradient for the measured viscosity to be independent of the rate gradient.

### Organopolysiloxane A

According to the invention, the curable silicone compositions X according to the invention comprise at least one organopolysiloxane A including at least one (meth)acrylate group, preferably at least two (meth)acrylate groups.

As representative of the (meth)acrylate functional groups carried by the silicone and most particularly suitable for the invention, we can cite in particular the derivatives of acrylates, methacrylates, ethers of (meth)acrylates and esters of (meth)acrylates linked to the polysiloxane chain by an Si—C bond.

According to one embodiment, the organopolysiloxane A comprises:
a) at least one unit having the following formula (I):

RₐZ_{b}SiO_{(4-a-b)/2} (I)

a formula in which:
the R symbols, which are identical or different, each represent a linear or branched C1 to C18 alkyl group, a C6 to C12 aryl or aralkyl group, said alkyl and aryl groups possibly being substituted, preferably by halogen atoms, or an —OR⁵ group with R⁵ being a hydrogen atom or a hydrocarbon group comprising from 1 to 10 carbon atoms,
the Z symbols are monovalent groups of formula-y-(Y′)n in which:
y represents a polyvalent C1-C18 alkylene or heteroalkylene group, said alkylene and heteroalkylene groups able to be linear or branched, and possibly being interrupted by one or more cycloalkylene groups, and possibly being extended by C1 to C4 oxyalkylene or polyoxyalkylene bivalent radicals, said alkylene, heteroalkylene, oxyalkylene, and polyoxyalkylene groups possibly being substituted by one or more hydroxy groups,
Y′ represents a monovalent alkenylcarbonyloxy group, and
n is equal to 1, 2, or 3, and
a is an integer equal to 0, 1, or 2, b is an integer equal to 1 or 2, and the sum a+b=1, 2, or 3; and
b) optionally units having the following formula (II):

RₐSiO_{(4-a)/2} (II)

a formula in which:
the R symbols are as defined above in formula (I), and
a is an integer equal to 0, 1, 2, or 3.

In formulas (I) and (II) above, the R symbols, which are identical or different, each represent a linear or branched C1 to C18 alkyl group or a C6 to C12 aryl or aralkyl group. Preferably, the R symbol represents a monovalent group chosen from the group composed of methyl, ethyl, propyl, 3,3,3-trifluoropropyl, xylyl, tolyl, and phenyl, and more preferably the R symbol represents a methyl.

The organopolysiloxane A can have a linear, branched, cyclic or network structure. Preferably, the organopolysiloxane A has a linear structure. When it concerns organopolysiloxanes, these can essentially consist of:
“D” siloxyl units chosen among units of formulas R₂SiO_{2/2}, RZSiO_{2/2}, and Z₂SiO_{2/2};
“M” siloxyl units chosen among units of formulas R₃SiO_{1/2}, R₂ZSiO_{1/2}, RZ₂SiO_{1/2}, and Z₃SiO_{1/2}, and
the R and Z symbols are as defined above in formula (I).

According to one embodiment, in formula (I) above, the aforementioned Y′ alkenylcarbonyloxy groups include acryloxy [CH₂═CH—CO—O—] and the methacryloxy group [CH₂═C(CH₃)—CO—O—]. Advantageously, the organopolysiloxane A comprises at least two Y′ alkenylcarbonyloxy groups, preferably at least three Y′ alkenylcarbonyloxy groups.

As illustrations of the y symbol in the units of formula (I), the following groups can be mentioned:
—CH₂—;
—(CH₂)₂—;
—(CH₂)₃—;
—CH₂-CH(CH₃)—CH₂—;
—(CH₂)₃-NR′—CH₂—CH₂—; where R′ is a C1-C6 alkyl group
—(CH₂)₃—OCH₂—;
—(CH₂)₃—[O—CH₂—CH(CH₃)—]n—; where n=1 to 25
—(CH₂)₃—O—CH₂—CH(OH)(—CH₂—) ;
—(CH₂)₃—O—CH₂—C(CH₂—CH₃)[—(CH₂—)]₂;
—(CH₂)₃—O—CH₂—C[—(CH₂)—]₃ and
—(CH₂)₂—C₆H₉(OH)—.

Preferably, organopolysiloxane A corresponds to the following formula (III):

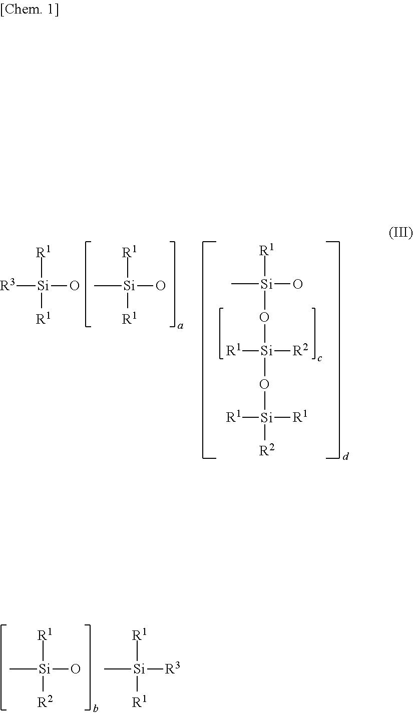

a formula in which:
the R¹ symbols, which are identical or different, each represent a linear or branched C₁ to C₁₈ alkyl group, a C₆ to C₁₂ aryl or aralkyl group, said alkyl and aryl groups possibly being substituted, preferably by halogen atoms, or an —OR⁵ group with R⁵ being a hydrogen atom or a hydrocarbon group comprising from 1 to 10 carbon atoms,
the R² and R³ symbols, which are identical or different, each represent either an R¹ group or a monovalent group of formula Z=-y-(Y′)n in which:
y represents a polyvalent C1-C18 alkylene or heteroalkylene group, said alkylene and heteroalkylene groups able to be linear or branched, and possibly being interrupted by one or more cycloalkylene groups, and possibly being extended by C1 to C4 oxyalkylene or polyoxyalkylene bivalent radicals, said alkylene, heteroalkylene, oxyalkylene, and polyoxyalkylene groups optionally being substituted by one or more hydroxy groups,
Y′ represents a monovalent alkenylcarbonyloxy group, and
n is equal to 1, 2, or 3, and
with a=0 to 1000, b=0 to 500, c=0 to 500, d=0 to 500, and a+b+c+d=0 to 2500, preferably a=0 to 500 and a+b+c+d=0 to 500, and
the condition that at least one R² or R³ symbol represents the monovalent group of formula Z, preferably at least two R² or R³ symbols represent a monovalent group of formula Z.

According to a preferred embodiment, in formula (III) above:
c=0, d=0, a=1 to 1000 (preferably a=1 to 499), b=1 to 250, the R² symbol represents the monovalent group of formula Z, and the R¹ and R³ symbols have the same meaning as above.

Even more preferably, in formula (III) above:
c=0, d=0, a=1 to 500 (preferably a=1 to 498), b=2 to 100, the R² symbol represents the monovalent group of formula Z, and the R¹ and R³ symbols have the same meaning as above.

According to one embodiment, in formula (III) above:
c=0, d=0, a=1 to 1000 (preferably a=1 to 499), b=1 to 250, the R² and R³ symbols represent the monovalent group of formula Z, and the R¹ symbols have the same meaning as above.

According to one embodiment, the organopolysiloxane A according to the invention corresponds to one of the following formulas (IV), (V), (VI) or (VII):

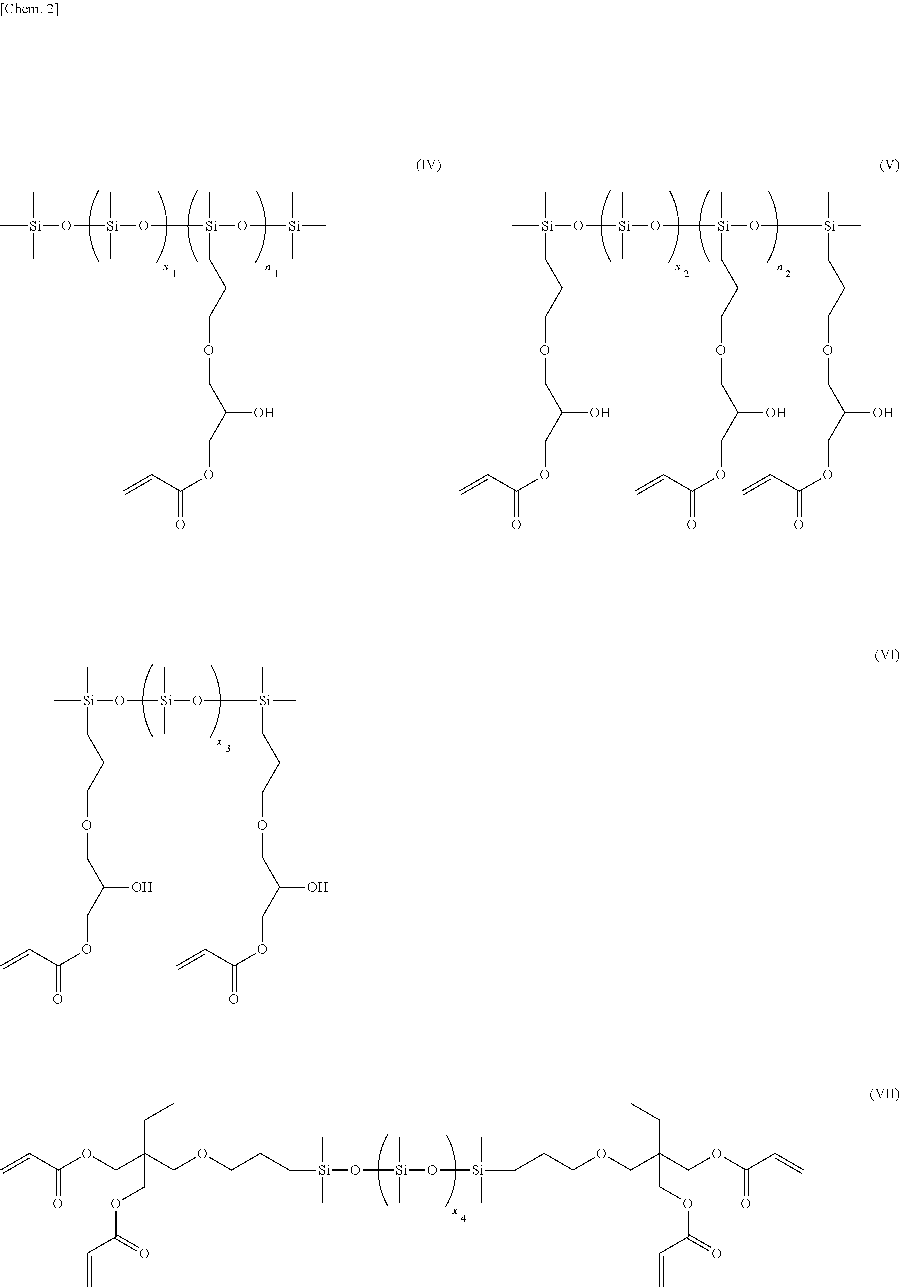

where:
x1 is between 1 and 1000; preferably x1 is between 1 and 500 or between 1 and 499,
n1 is between 1 and 100, preferably n1 is between 2 and 100,
x2 is between 1 and 1000, preferably x2 is between 1 and 500 or between 1 and 499,
n2 is between 1 and 100, preferably n2 is between 2 and 100,
x3 is between 1 and 1000, preferably x3 is between 1 and 500, and
x4 is between 1 and 1000, preferably x4 is between 1 and 500.

The radiation-curable silicone composition X can comprise between 25 and 75% organopolysiloxane A, relative to the total weight of the radiation-curable silicone composition X.

The organopolysiloxane A can have a molar content of (meth)acrylate functional group that is greater than or equal to 30 mmol/100 g of organopolysiloxane A, preferably between 35 and 250 mmol/100 g of organopolysiloxane A.

The organopolysiloxane A can have a molar content of (meth)acrylate functional group that is greater than or equal to 60 mmol/100 g of organopolysiloxane A, preferably between 65 and 250 mmol/100 g of organopolysiloxane A.

The radiation-curable silicone composition X can comprise a single organopolysiloxane A or a mixture of several organopolysiloxanes A having, for example, different acrylate contents. When the radiation-curable composition X comprises a mixture of several organopolysiloxanes A, several embodiments are possible.

The organopolysiloxane A can for example comprise:
at least one organopolysiloxane having a high molar content of (meth)acrylate functional group (for example, greater than or equal to 30 or 60 mmol/100 g of organopolysiloxane), and
at least one organopolysiloxane with a low molar content of (meth)acrylate functional group (for example, respectively less than 30 or 60 mmol/100 g of organopolysiloxane).

According to a first embodiment, the organopolysiloxane A comprises:
a1. at least one organopolysiloxane A1 including at least one (meth)acrylate group, and having a molar content of (meth)acrylate functional group that is greater than or equal to 30 mmol/100 g of organopolysiloxane A1, preferably between 35 and 250 mmol/100 g of organopolysiloxane A1; and
a2. at least one organopolysiloxane A2 including at least one (meth)acrylate group, and having a molar content of (meth)acrylate functional group that is less than 30 mmol/100 g of organopolysiloxane A2, preferably between 1 and 30 mmol/100 g of organopolysiloxane A2, and even more preferably between 15 and 25 mmol/100 g of organopolysiloxane A2.

According to a second embodiment, the organopolysiloxane A comprises:
a1. at least one organopolysiloxane A1′ including at least one (meth)acrylate group, and having a molar content of (meth)acrylate functional group that is greater than or equal to 60 mmol/100 g of organopolysiloxane A1′, preferably between 65 and 250 mmol /100 g of organopolysiloxane A1′; and
a2. at least one organopolysiloxane A2′ including at least one (meth)acrylate group, and having a molar content of (meth)acrylate functional group that is less than 60 mmol/100 g of organopolysiloxane A2′, preferably between 1 and 60 mmol/100 g of organopolysiloxane A2′, and even more preferably between 15 and 55 mmol/100 g of organopolysiloxane A2′.

The content of (meth)acrylate functional group is expressed in mmol/100 g of organopolysiloxane A, A1, A1′, A2, or A2′.

The organopolysiloxanes A1, A1′, A2, and A2′ can be as described above for organopolysiloxane A.

The combination of two organopolysiloxanes A1 and A2, or A1′ and A2′, having a different molar acrylate content makes it possible to control the adhesion of the coating obtained after curing, relative to an adhesive. Indeed, it is possible to control the adhesion of the coating obtained after curing, relative to an adhesive, according to the desired application, by adjusting the amount of organopolysiloxane A2 or A2′ in the silicone composition X.

The silicone composition X can comprise between 0.1 and 10% by weight of organopolysiloxane A2 or A2′, preferably between 1 and 8% by weight, relative to the total weight of the radiation-curable silicone composition X.

Thus, the silicone composition X can comprise:
between 25 and 74.9% by weight of organopolysiloxane A1 or A1′, preferably between 25 and 65% by weight, relative to the total weight of the radiation-curable silicone composition X, and
between 0.1 and 10% by weight of organopolysiloxane A2 or A2′, preferably between 1 and 8% by weight, relative to the total weight of the radiation-curable silicone composition X.

The proportion of organopolysiloxane A2 or A2′ compared to organopolysiloxane A1 or A1′ can be expressed by a mass ratio A2:A1 or A2′:A1′. Preferably, this ratio is between 1:65 and 1:2, more preferably between 1:50 and 1:3, and even more preferably between 1:40 and 1:5.

### Organopolysiloxane Resin B Comprising Si—OH Groups

The organopolysiloxane resin B comprising Si—OH groups makes it possible to control the adhesion of the coating obtained after curing, relative to an adhesive. The organopolysiloxane resin B also makes it possible to obtain a coating whose release profile is “smooth”, meaning the release forces remain stable throughout the step of delaminating the complex (separating the adhesive and the silicone liner).

According to one embodiment, the radiation-curable silicone composition X comprises between 25 and 60% by weight of resin B, preferably between 25 and 50% by weight.

Organopolysiloxane resin B is a well-known, commercially available branched organopolysiloxane oligomer or polymer. The resin comprises at least one T unit and/or at least one Q unit. It also comprises at least one OH functional group bonded to a silicon atom in its structure: it therefore comprises Si—OH groups.

The OH functional groups can be carried by T and/or Q units. Thus, the organopolysiloxane resins B useful in the invention can comprise T(OH) units and/or Q(OH) units, with T(OH)=(OH)R⁴SiO_{2/2} and Q(OH)=(OH)SiO_{3/2}, the R⁴ group being chosen from linear or branched C1-C6 alkyl groups, C2-C4 alkenyl groups, the phenyl group, and the 3,3,3-trifluoropropyl group. Examples for the R⁴ group include alkyls, the methyl, ethyl, isopropyl, tert-butyl, and n-hexyl groups. Preferably, the R⁴ group is a methyl radical.

Examples of organopolysiloxane B resins include MDT resins, DT resins, and MQ resins.

The MDT resins comprise units M=(R⁴)₃SiO_{1/2}, D=(R⁴)₂SiO_{2/2}, and T=R⁴SiO_{3/2}, and some of the T units comprise OH groups. Thus the MDT resins also comprise T(OH)=(OH)R⁴SiO_{2/2} units. In these formulas, the R⁴ groups are as described above.

The DT resins comprise units D=(R⁴)₂SiO_{2/2}, and T=R⁴SiO_{3/2}, and part of the T units comprise OH groups. Thus the DT resins also comprise T(OH)=(OH)R⁴SiO_{2/2} units. In these formulas, the R⁴ groups are as described above.

The MQ resins comprise units M=(R⁴)₃SiO_{1/2}, and Q=SiO_{3/2}, and part of the Q units comprise OH groups. Thus the MQ resins also comprise Q(OH)=(OH)SiO_{3/2} units. In these formulas, the R⁴ groups are as described above.

According to a preferred embodiment, the R⁴ groups are chosen independently of each other among linear or branched C1-C6 alkyl groups and the 3,3,3-trifluoropropyl group.

Preferably the resin B is an MDT or MQ resin.

When resins with a Q unit are used, they can have a molar ratio M/(T+Q) comprised between 0.5 and 1.5, preferably comprised between 0.7 and 1.2.

The OH functional group content of the resin B can be between 0.2 and 5% by weight. According to one embodiment, the OH functional group content is at least 0.5% by weight. Preferably, the OH functional group content is between 0.5 and 5% by weight, more preferably between 0.6 and 4.5% by weight, and even more preferably between 0.7 and 4% by weight. The OH functional group content is expressed as the weight of the OH functional groups relative to the total weight of the resin B.

The resin B generally has an average molecular weight comprised between 500 and 10,000 g/mol, preferably between 1,000 and 6,000 g/mol.

The radiation-curable silicone composition X can comprise a single resin B or a mixture of several resins B.

### Radical Photoinitiator C

The radiation-curable silicone composition can comprise a radical photoinitiator C. This is particularly the case when the composition is curable by photon irradiation, under radiation having a wavelength of between 200 nm and 450 nm, in particular UV radiation.

The radical photoinitiator C releases free radicals in the medium, under the effect of absorption of the incident light energy. These radicals act as initiators of free-radical polymerization of the (meth)acrylic functional groups.

The radical photoinitiators include aromatic ketones which, after exposure to ultraviolet (UV) radiation:
undergo a homolytic cleavage at the a position of the carbonyl functional group with the formation of two radical fragments, of which one is a benzoyl radical (type I photoinitiators), or
form free radicals when they are promoted to their excited states by stripping hydrogen from a hydrogen donor molecule (more commonly referred to as “co-initiator”) which leads to the formation of an inactive cetyl radical and an initiator radical which comes from the corresponding donor (type II photoinitiators).

These photoinitiators are well known to those skilled in the art. Examples of type I photoinitiators include α-hydroxyketones, benzoin ethers, and α-amino aromatic ketones.

Examples of type II photoinitiators include isopropylthioxanthone (ITX), benzophenone, and camphorquinone (CQ). Examples of co-initiators include phenyl tetrazole thiol, tris(trimethylsilyl)silane, and aromatic amines such as ethyl dimethylaminobenzoate (EDB).

Examples of photoinitiators are for example described in patents FR2632960, EP0940422-B1, EP0979851-B1, EP1544232-B1, and EP1411095A2. The photoinitiator conventionally used is Irgacure® 1173 (formerly Darocur® 1173) from BASF.

Examples of radical photoinitiators C include the following products in particular: isopropylthioxanthone; benzophenone; camphorquinone; 9-xanthenone; anthraquinone; 1,4-dihydroxyanthraquinone; 2-methylanthraquinone; 2,2′-bis(3-hydroxy-1,4-naphthoquinone); 2,6-dihydroxyanthraquinone; 1-hydroxycyclohexyl phenyl ketone; 1,5-dihydroxyanthraquinone; 1,3-diphenyl-1,3-propanedione; 5,7-dihydroxyflavone; dibenzoylperoxide; 2-benzoylbenzoic acid; 2-hydroxy-2-methylpropiophenone; 2-phenylacetophenone; anthrone; 4,4′-dimethoxybenzoin; phenanthrenequinone; 2-ethylanthraquinone; 2-methylanthraquinone; 2-ethylanthraquinone; 1,8-dihydroxyanthraquinone; dibenzoyl-peroxide; 2,2-dimethoxy-2-phenylacetophenone; benzoin; 2-hydroxy-2-methylpropiophenone; benzaldehyde; 4-(2-hydroxyethoxy)phenyl-(2-hydroxy-2-methylpropyl)ketone; benzoylacetone; ethyl(2,4,6-trimethylbenzoyl) phenylphosphinate; and mixtures thereof.

Examples of commercial products of radical photoinitiators C according to the invention can also include, among the benzophenone derivatives, the products Esacure® TZT, Speedcure® MBP, Omnipol® BP; and among the thioxanthone derivatives, the products Irgacure® 907, Omnipol® TX, and Genopol® TX-1.

According to one particular embodiment, the radical photoinitiator C is chosen from the group composed of benzophenone and its derivatives, thioxanthone and its derivatives, anthraquinone and its derivatives, benzoyl formate esters, camphorquinone, benzil, phenanthrenequinone, coumarins and ketocoumarins, and mixtures thereof. Examples of these radicals are for example described in application WO2017/109116.

Benzophenone derivatives refer to substituted benzophenones and polymeric versions of benzophenone.

Thioxanthone derivatives refer to substituted thioxanthones, and anthraquinone derivatives refer to substituted anthraquinones, in particular anthraquinone sulfonic acids and acrylamido-substituted anthraquinones.

The benzoyl formate esters include methyl benzoylformate, optionally bifunctional.

Effective examples of radical photoinitiators C are also described in patent application EP0007508. According to one embodiment, the radical photoinitiator C is chosen from the group composed of the derivatives: 2,2-dimethyl-propionyldiphenylphosphine oxide, 2,2-dimethyl-heptanoyl-diphenylphosphine oxide, 2,2-dimethyl-octanoyl-diphenylphosphine oxide, 2,2-dimethyl-nonanoyl-diphenylphosphine oxide, methyl 2,2-dimethyl-octanoyl-phenylphosphinate, 2-methyl-2-ethyl hexanoyl-diphenylphosphine oxide, 1-methyl-1-cyclohexanecarbonyl-diphenylphosphine oxide, 2,6-dimethyl benzoyi-diphenylphosphine oxide, 2,6-dimethoxybenzoyl-diphenylphosphine oxide, 2,6-dichlorobenzoyl-diphenylphosphine oxide, methyl 2,6-dimethoxybenzoyl-phenylphosphinate, 2,4,6-trimethylbenzoyl-diphenylphosphine oxide, methyl 2,4,6-trimethylbenzoylphenylphosphinate, 2,3,6-trimethylbenzoyldiphenylphosphine oxide, 2,3,5,6-tetramethylbenzoyl-diphenylphosphine oxide, 2,4,6-trimethoxybenzoyl-diphenylphosphine oxide, 2,4,6-trichlorobenzoyldiphenylphosphine oxide, 2-chloro-6-methyl-thio-benzoyl-diphenylphosphine oxide, methyl-2,4,6-trimethyl-benzoyl-naphthylphosphinate, 1,3-dimethoxynaphthalene-2-carbonyl-diphenylphosphine oxide, and 2,8-dimethoxynaphthalene-1-carbonyl-diphenylphosphine oxide.

According to a particularly preferred embodiment, the radical photoinitiator C is ethyl(2,4,6-trimethylbenzoyl) phenylphosphinate (CAS No. 84434-11-7).

Preferably, the effective amount of radical photoinitiator C is between 0.1% and 20% by weight relative to the total weight of the radiation-curable silicone composition X, or of the functionalized organopolysiloxane A, and preferably between 0.1 and 10% by weight, and even more preferably between 0.1% and 5% by weight.

### Organic Compound D

The radiation-curable silicone composition X can comprise an organic compound D comprising at least one (meth)acrylate functional group.

The radiation-curable silicone composition X can comprise one organic compound D or several different organic compounds D.

The presence of the organic compound D comprising at least one (meth)acrylate functional group makes it possible to obtain, after curing the silicone composition X, a coating having release forces, relative to an adhesive, which are stable with aging.

Advantageously, the radiation-curable silicone composition X comprises between 0.1 and 30% by weight of organic compound D comprising a (meth)acrylate functional group, preferably between 1 and 25% by weight, and more preferably between 3 and 22% by weight.

Organic compound D comprising at least one (meth)acrylate functional group is understood to mean any compound comprising one or more (meth)acrylate functional groups. According to one embodiment, the organic compound D comprising at least one (meth)acrylate functional group does not comprise a siloxane structure.

Suitable in particular as organic compounds D comprising a (meth)acrylate functional group are the epoxidized (meth)acrylates, the (meth)acryloglyceropolyesters, (meth)acrylouretanes, (meth)acrylopolyethers, (meth)acrylopolyesters, and (meth)acryloacrylics. More particularly preferred are trimethylolpropane triacrylate, tripropylene glycol diacrylate, hexanediol diacrylate, and pentaerythritol tetraacrylate.

Examples of an organic compound D comprising a (meth)acrylate functional group include: ethylhexyl acrylate, stearyl acrylate, tetrahydrofurfuryl acrylate, lauryl acrylate, isodecyl acrylate, 2-(2-ethoxyethoxy)ethyl acrylate, cyclohexyl acrylate, isooctyl acrylate, tridecyl acrylate, isobornyl acrylate, caprolactone acrylate, alkoxylated phenol acrylates, 1,3-butylene glycol diacrylate, 1,4-butanediol diacrylate, diethylene glycol diacrylate, neopentyl glycol diacrylate, tetraethylene glycol diacrylate, triethylene glycol diacrylate, dipropylene glycol diacrylate, alkoxylated hexanediol diacrylates, trimethylolpropane triacrylate, ethoxylated trimethylolpropane triacrylate, propoxylated glycerol triacrylate, pentarythritol triacrylate, pentaerythritol tetraacrylate, di-trimethylolpropane tetraacrylate, and di-pentaerythritol pentaacrylate.

### Other Additives

The radiation-curable silicone composition X can also comprise other additives such as polymerization inhibitors, fillers, virucides, bactericides, anti-abrasion additives, and pigments (organic or inorganic). The polymerization inhibitors include phenols, hydroquinone, 4-OMe-phenol, 2,4,6-tritertiary-butylphenol (BHT), phenothiazine, and nitroxyl radicals such as (2,2,6,6-tetramethylpiperidin-1-yl)oxyl (TEMPO).

According to one embodiment, the radiation-curable silicone composition X comprises:
a. at least one organopolysiloxane A including at least one (meth)acrylate group; said organopolysiloxane A corresponding to the following formula (III) :

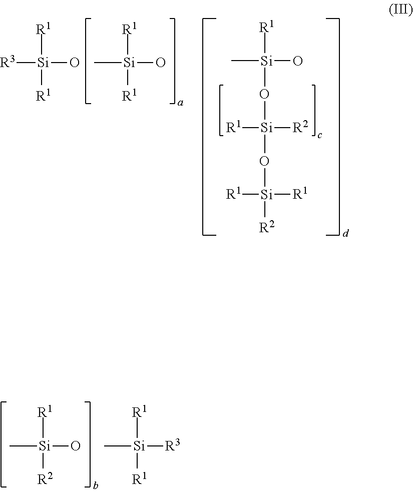

a formula in which:
   the R¹ symbols, which are identical or different, each represent a linear or branched C₁ to C₁₈ alkyl group, a C₆ to C₁₂ aryl or aralkyl group, said alkyl and aryl groups possibly being substituted, preferably by halogen atoms, or an —OR⁵ group with R⁵ being a hydrogen atom or a hydrocarbon group comprising from 1 to 10 carbon atoms,
   the R² and R³ symbols, which are identical or different, each represent either an R¹ group or a monovalent group of formula Z=-y-(Y′)n in which:
   y represents a polyvalent C1-C18 alkylene or heteroalkylene group, said alkylene and heteroalkylene groups able to be linear or branched, and possibly being interrupted by one or more cycloalkylene groups, and possibly being extended by C1 to C4 oxyalkylene or polyoxyalkylene bivalent radicals, said alkylene, heteroalkylene, oxyalkylene, and polyoxyalkylene groups optionally being substituted by one or more hydroxy groups,
   Y′ represents a monovalent alkenylcarbonyloxy group, and
   n is equal to 1, 2, or 3, and
   with a=0 to 500, b=0 to 500, c=0 to 500, d=0 to 500, and a+b+c+d=0 to 500, and
the condition that at least one R² or R³ symbol represents the monovalent group of formula Z, preferably at least two R² or R³ symbols represent a monovalent group of formula Z;
b. at least 25% by weight of an organopolysiloxane resin B comprising Si—OH groups; and
c. optionally, at least one radical photoinitiator C.

### Premix for Silicone Composition

It is possible to prepare the radiation-curable silicone composition X by mixing the various components.

Nevertheless, when the radiation-curable silicone composition X comprises an organic compound D comprising at least one (meth)acrylate functional group, it is also possible to prepare the radiation-curable silicone composition X by using a premix comprising:
a. between 20 and 40% by weight of at least one organopolysiloxane A including at least one (meth)acrylate group;
b. between 30 and 50% by weight of an organopolysiloxane resin B comprising Si—OH groups; and
c. between 10 and 30% by weight of an organic compound D comprising a (meth)acrylate functional group.

This premix can then be diluted in the organopolysiloxane A to form the radiation-curable silicone composition X. This premix can have a viscosity of between 500 and 2000 mPa·s, which allows easily diluting it in the organopolysiloxane A. This makes it possible to easily form a radiation-curable silicone composition X having a viscosity that is compatible with coating tools. With this premix, it is also possible to easily control the concentration of organopolysiloxane resin B in the radiation-curable silicone composition X, and therefore to easily control the adhesion of the coating obtained after curing, relative to an adhesive.

This premix also makes it possible to obtain silicone compositions having better homogeneity, which is important when used on coating devices comprising rollers operating at very high speed.

One object of the invention is therefore a premix for a silicone composition, comprising:
a. between 20 and 40% by weight of at least one organopolysiloxane A including at least one (meth)acrylate group;
b. between 30 and 50% by weight of an organopolysiloxane resin B comprising Si—OH groups; and
c. between 10 and 30% by weight of an organic compound D comprising a (meth)acrylate functional group.

The compounds A, B, and D are as described above for the radiation-curable silicone composition X.

### Radiation-Curable Silicone Composition X1 or X1′

Another object of the present invention is a radiation-curable silicone composition X1 comprising:
a. 1) at least one organopolysiloxane A1 including at least one (meth)acrylate group, and having a molar content of (meth)acrylate functional group that is greater than or equal to 30 mmol/100 g of organopolysiloxane A1, preferably between 35 and 250 mmol/100 g organopolysiloxane A1;
a. 2) at least one organopolysiloxane A2 including at least one (meth)acrylate group, and having a molar content of (meth)acrylate functional group that is less than 30 mmol/100 g of organopolysiloxane A2, preferably between 1 and 30 mmol/100 g of organopolysiloxane A2, and even more preferably between 15 and 25 mmol/100 g of organopolysiloxane A2;
b. at least one organopolysiloxane resin B comprising Si—OH groups; and
c. optionally, at least one radical photoinitiator C.

Another object of the present invention is a radiation-curable silicone composition X1′ comprising:
a. 1) at least one organopolysiloxane A1′ including at least one (meth)acrylate group, and having a molar content of (meth)acrylate functional group that is greater than or equal to 60 mmol/100 g of organopolysiloxane A1′, preferably between 65 and 250 mmol /100 g of organopolysiloxane A1′;
a. 2) at least one organopolysiloxane A2′ including at least one (meth)acrylate group, and having a molar content of (meth)acrylate functional group that is less than 60 mmol/100 g of organopolysiloxane A2′, preferably between 1 and 60 mmol/100 g of organopolysiloxane A2′, and even more preferably between 15 and 55 mmol/100 g of organopolysiloxane A2′;
b. at least one organopolysiloxane resin B comprising Si—OH groups; and
c. optionally, at least one radical photoinitiator C.

These radiation-curable silicone compositions X1 and X1′ can comprise between 0.5 and 60% by weight of resin B, preferably between 10 and 50% by weight.

According to one embodiment, the radiation-curable silicone composition X1 comprises between 0.1 and 10% by weight of organopolysiloxane A2, preferably between 2 and 8% by weight.

The silicone composition X1 can comprise:
between 25 and 74.9% by weight of organopolysiloxane A1, preferably between 25 and 65% by weight, relative to the total weight of the radiation-curable silicone composition X1; and
between 0.1 and 10% by weight of organopolysiloxane A2, preferably between 1 and 8% by weight, relative to the total weight of radiation-curable silicone composition X1.

According to one embodiment, the radiation-curable silicone composition X1′ comprises between 0.1 and 10% by weight of organopolysiloxane A2′, preferably between 2 and 8% by weight.

The silicone composition X1′ can comprise:
between 25 and 74.9% by weight of organopolysiloxane A1′, preferably between 25 and 65% by weight, relative to the total weight of the radiation-curable silicone composition X1′; and
between 0.1 and 10% by weight of organopolysiloxane A2′, preferably between 1 and 8% by weight, relative to the total weight of the radiation-curable silicone composition X1′.

The proportion of organopolysiloxane A2 or A2′ compared to organopolysiloxane A1 or A1′ can be expressed by a mass ratio A2:A1 or A2′:A1′.Preferably, this ratio is between 1:65 and 1:2, preferably between 1:50 and 1:3, and even more preferably between 1:40 and 1:5.

These radiation-curable silicone compositions X1 and X1′ can further comprise an organic compound D comprising a (meth)acrylate functional group.

Compounds A1, A1′, A2, A2′, B, C, and D are as described above for the radiation-curable silicone composition X.

These radiation-curable silicone compositions X1 and X1′ can also be used for the same applications as those described below for radiation-curable silicone composition X.

The combination of two organopolysiloxanes A1 and A2, or A1′ and A2′, having a different acrylate molar content makes it possible to control the adhesion of the coating obtained after curing. Indeed, it is possible to control the adhesion of the coating obtained after curing, according to the desired application, by adjusting the amount of organopolysiloxane A2 or A2′ in the silicone compositions X1 or X1′.

### Applications

The invention also relates to the use of the radiation-curable silicone composition X for the preparation of silicone elastomers. These silicone elastomers can have release properties relative to adhesives.

The invention also relates to a method for preparing silicone elastomers, comprising a step of curing a radiation-curable silicone composition X.

According to one embodiment of the method of the invention, the curing step is carried out in air or in an inert atmosphere. Preferably, this curing step is carried out in an inert atmosphere.

According to one embodiment, the curing step of the method according to the invention is carried out by UV radiation having a wavelength of between 200 nm and 450 nm, preferably in an inert atmosphere.

According to another embodiment, the curing step of the method according to the invention is carried out by exposure to an electron beam or to gamma rays.

The UV radiation can be emitted by doped or undoped mercury vapor lamps whose emission spectrum extends from 200 nm to 450 nm. Light sources such as light-emitting diodes, better known by the acronym “LED”, which deliver spot UV or visible light can also be used.

According to a preferred mode of the invention, the radiation is ultraviolet light of a wavelength of less than 400 nanometers. According to a preferred mode of the invention, the radiation is ultraviolet light of a wavelength greater than 200 nanometers.

According to one advantageous embodiment, LED UV lamps are used (UV emissions at 365, 375, 385, and/or 395 nm).

A dose of ultraviolet radiation within the range of about 0.1 to about 0.5 joules is generally sufficient to induce crosslinking.

The radiation time can be short and is generally less than 1 second and is on the order of several hundredths of a second for low coating thicknesses. The crosslinking obtained is excellent even in the absence of any heating.

According to one embodiment, the curing step is carried out at a temperature between 10° C. and 50° C., preferably between 15° C. and 35° C.

Of course, the curing speed can be adjusted in particular by the number of UV lamps used, by the duration of the exposure to UV, and by the distance between the composition and the UV lamp.

The invention also relates to a method for preparing a coating on a substrate, comprising the following steps:
applying a radiation-curable silicone composition X onto a substrate, and
curing said composition by electron or photon irradiation, preferably by exposure to an electron beam, by exposure to gamma rays, or by exposure to radiation having a wavelength of between 200 nm and 450 nm, in particular UV radiation.

The solventless composition X according to the invention, i.e. undiluted, can be applied using devices suitable for uniformly depositing small quantities of liquids. For this purpose, one can use for example the device known as “Helio glissant”, comprising in particular two superimposed rollers: the role of the lower roller, which is immersed into the coating tank where the compositions are located, is to impregnate the upper roller in one thin layer, the role of the latter then being to deposit on the paper the desired amounts of the compositions with which it is impregnated, such dosing being obtained by adjusting the respective speed of the two rollers which rotate in opposite directions relative to each other.

Crosslinking, which results in the curing of the silicone composition X, can be carried out continuously by passing the substrate coated with the composition through an irradiation device which is designed to ensure sufficient dwell time for the coated substrate to complete the curing of the coating. Preferably, the curing is carried out in the presence of the lowest possible concentration of oxygen, typically at an oxygen concentration of less than 100 ppm, and preferably less than 50 ppm. The curing is generally carried out in an inert atmosphere, for example nitrogen or argon. The exposure time required to cure the silicone composition X varies with factors such as:
the particular formulation used, the radiation type and wavelength,
the dose flow rate, the energy flux,
the concentration of radical photoinitiator, and
the atmosphere and the thickness of the coating.

These parameters are well known to those skilled in the art, who will know how to adapt them.

The amounts of composition X deposited on the substrates are variable and most often range between 0.1 and 5 g/m² of treated surface. These amounts depend on the nature of the substrates and on the release properties desired. They are most often between 0.5 and 1.5 g/m² for non-porous substrates.

This method is particularly suitable for preparing a silicone release coating on a substrate which is a flexible substrate made of textile, paper, polyvinyl chloride, polyester, polypropylene, polyamide, polyethylene, polyethylene terephthalate, polyurethane, or non-woven fiberglass.

Flexible substrates coated with a silicone release coating can be for example:
a paper or a polymer film of the polyolefin type (polyvinyl chloride (PVC), PolyPropylene or Polyethylene) or of the polyester type (PolyEthylene Terephthalate or PET),
an adhesive tape whose inner face is coated with a layer of pressure-sensitive adhesive and whose outer face comprises the silicone release coating;
or a polymer film for protecting the adhesive face of a self-adhesive element or a pressure-sensitive adhesive.

These coatings are particularly suitable for use in the release coating field.

The invention also relates to a coated substrate that is obtainable according to the method described above. As indicated above, the substrate can be a flexible substrate made of textile, paper, polyvinyl chloride, polyester, polypropylene, polyamide, polyethylene, polyethylene terephthalate, polyurethane, or non-woven glass fibers.

The coated substrates have non-stick and water-repellent features, or allow improved surface properties such as slipperiness, stain resistance, or softness.

Another object of the invention relates to the use of a substrate at least partially coated with a release coating according to the invention and as defined above, in the field of self-adhesive labels, strips including envelopes, graphic arts, medical care and hygiene.

### EXAMPLES

In the examples below, various organopolysiloxanes A, resins B, radical photoinitiators C, and organic compounds D are used to prepare radiation-curable silicone compositions X according to the invention. Their structures are shown in the tables below. Unless otherwise stated, throughout this document the percentages are expressed in % by weight.

### Organopolysiloxanes A

TABLE 1

| | | Acrylate content |
|---|---|---|
| | | (mmol/100 g |
| Compound | Formula | organopolysiloxane) |
| A1 | 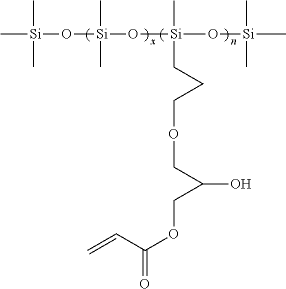 | 90 |
| A2 | 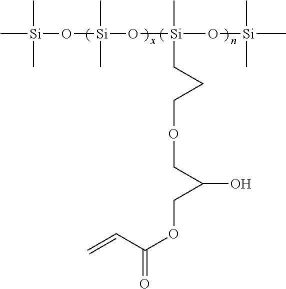 | 20 |
| A3 | 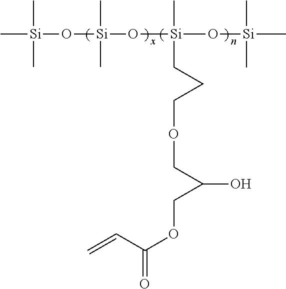 | 200 |
| A4 | 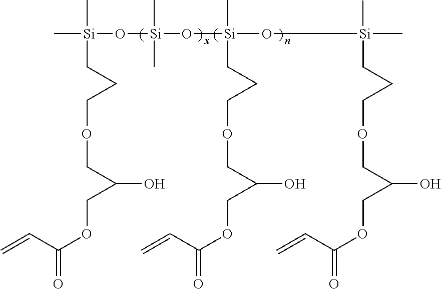 | 55 |

### Organopolysiloxane Resin B Comprising Si—OH Groups

B1: MQ resin with part of the Q units comprising OH groups, with an OH functional group content of 2% by weight and an average molar mass of 5500 g/mol

B2: MQ resin with part of the Q units comprising OH groups, with an OH functional group content of 3% by weight and an average molar mass of 6000 g/mol

B3: MQ resin with part of the Q units comprising OH groups, with an OH functional group content of 1.6% by weight and an M/Q ratio of 1.1

B4: MDT resin with part of the T units comprising OH groups, with an OH functional group content of 0.8% by weight and an average molar mass of between 1000 and 6000 g/mol.

Radical photoinitiators C having the following formula

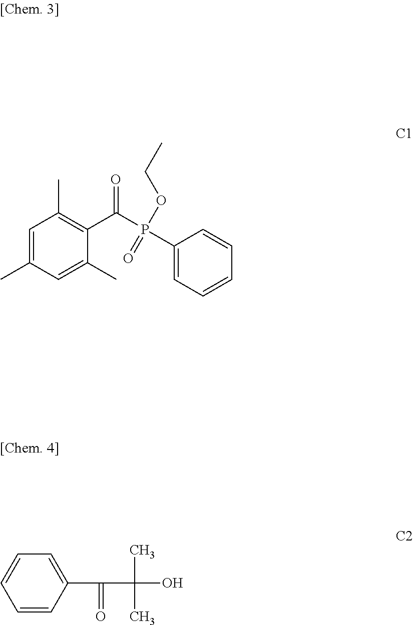 [SMILES: CCOP(=O)(C(=O)c1c(C)cc(C)cc1C)c1ccccc1 ; CC(C)(O)C(=O)c1ccccc1]

### Organic Compound D

D1: hexanediol diacrylate

D2: tripropylene glycol diacrylate

D3: trimethylolpropane triacrylate

The compositions are prepared as follows: Since the resins are diluted in organic solvents such as toluene, a solvent exchange with organopolysiloxane A1 is first carried out. The organic solvent is then evaporated, then the other components are added.

When the composition comprises an organic compound D, a premix according to the invention is prepared. Since the resins are diluted in organic solvents such as toluene, a solvent exchange with the organic compound D is first carried out. The organic solvent is then evaporated and the mixture is diluted in organopolysiloxane A1 to form the premix. The other components are then added to the premix to form the composition.

The compositions tested are presented in Tables 2 and 3.

TABLE 2

| | Comp. | Comp. | Comp. | | | | | | |
|---|---|---|---|---|---|---|---|---|---|
| Compound | Ex. 1 | Ex. 2 | Ex. 3 | Ex. 1 | Ex. 2 | Ex. 3 | Ex. 4 | Ex. 5 | Ex. 6 |
| A1 | 98 | | 90.5 | 69 | 69 | 61 | 62 | 62 | 62 |
| A2 | | | | | | | | | |
| A3 | | 98 | | | | | 5 | 5 | 5 |
| B1 | | | | 29 | | 29 | 25 | | |
| B2 | | | | | 29 | | | | |
| B3 | | | | | | | | 25 | |
| B4 | | | | | | | | | 25 |
| C1 | 2 | 2 | 2 | 2 | 2 | 2 | 2 | 2 | 2 |
| C2 | | | | | | | | | |
| D1 | | | 7.5 | | | | 6 | 6 | 6 |
| D2 | | | | | | 8 | | | |

TABLE 3

| Compound | Ex. 7 | Ex. 8 | Ex. 9 | Ex. 10 | Ex. 11 | Ex. 12 | Ex. 13 | Ex. 14 | Ex. 15 | Ex. 16 |
|---|---|---|---|---|---|---|---|---|---|---|
| A1 | 27 | 34 | 41 | 48 | 31 | 54 | 33 | 51 | 30 | 16.1 |
| A2 | 8 | 8 | 8 | 8 | 8 | 2 | 2 | 5 | 5 | |
| A3 | | | | | | | | | | 15.3 |
| A4 | | | | | | | | | | 28.5 |
| B1 | 44 | 39 | 34 | 29.5 | 42 | 29 | 44 | 29 | 44 | 26.5 |
| B2 | | | | | | | | | | |
| B3 | | | | | | | | | | |
| B4 | | | | | | | | | | |
| C1 | 2 | 2 | 2 | 2 | | 2 | 2 | 2 | 2 | 1.1 |
| C2 | | | | | 1 | | | | | |
| D1 | 19 | 17 | 15 | 12.5 | 18 | 13 | 19 | 13 | 19 | 11.3 |
| D2 | | | | | | | | | | |
| D3 | | | | | | | | | | 1.4 |

### Tests Carried Out on Substrates Coated With Silicone Release Coatings

Coating tests on a pilot line followed by release coating tests were carried out. To do this, the above formulations are coated using a coating pilot line. The machine speed is 100 m/min with the lamp power set at 150 W/cm. The coated substrate is PP on which is deposited a layer of silicone acrylate of 0.9 g/m² +/−0.1 g/m².This deposit is verified by XRF measurement. Upon exiting the machine, smear and rub-off tests are carried out.

Deposit: Verification of the silicone deposit coated on the surface, by X-ray fluorescence analysis of the silicon (Lab-X 3000 from Oxford). An X-ray tube excites the electron shell of the silicon atoms, which causes an emission of X-rays proportional to the amount of excited silicon. This value or number of counts is converted by calculation (using the standard curve) into the amount of silicone.

Smear: Qualitative verification of surface polymerization by the finger smear method which consists of:
Laying the sample of silicone-coated substrate to be checked on a flat and rigid surface;
Drawing a line with the fingertip while pressing moderately but distinctly; and
Examining the line thus made by eye, preferably in oblique light. We can thus see the presence of a finger mark, even very slight, by a difference in the gloss of the surface.

The assessment is qualitative. “Smear” is quantified by the following notations:
A: very good, no line left by finger
B: slightly less good, barely visible line
C: clear line
D: very clear line and oily appearance of the surface, product barely polymerized i.e. a grade from A to D, from best result to worst.

Rub-off: Verifying the ability of the silicone to adhere to the flexible substrate by rubbing back and forth with the finger, which consists of:
Laying the sample of silicone-coated substrate to be checked on a flat and rigid surface, the silicone being on the upper side;
Rubbing the fingertip back and forth 10 times (over a length of about 10 cm) while pressing moderately but distinctly;
Visually examining the appearance of the rubbed area. Rub-off corresponds to the appearance of a fine white powder or small balls which roll under the finger. The assessment is qualitative. Rub-off is quantified by the following notations:
10: very good, no rub-off after 10 rubs back and forth
1: very bad, rub-off at the first rub
The score corresponds to the number of rubs back and forth (from 1 to 10) at which rub-off appears,
i.e. a score of 1 to 10, from the weakest to the best result.

### Preparation of Self-Adhesive Multilayer Items

Standard adhesive substrates, TESA 7475 (acrylic) and TESA 4651 (rubber), are laminated to the silicone liner produced above (=substrate coated with a silicone coating obtained by crosslinking under UV) in order to form a multilayer item. Tensile tests are carried out in order to determine the release forces before and after aging, as well as the subsequent adhesion values. These tests are described below.

### Test Carried Out on the Multilayer Items Obtained

Subsequent adhesion or “SubAd”: Measurement verifying the residual tack of adhesives (TESA 7475) having been in contact with the silicone coating according to the FINAT 11 (FTM 11) test known to the skilled person. Here the reference test specimen is PET, and the adhesives remained in contact with the silicone surface to be tested for 1 day at 70° C.

The results are expressed in % residual adhesive force of the reference tape: CA=(Fm2/Fm1)×100 as a %, with:
Fm2=Average tape release force after contact with silicone substrate for 20 h; and
Fm1=Average tape release force without contact with silicone substrate.
Adhesion above 90% is desired.

Release: The peeling force measurements are carried out with the standard adhesives TESA 7475 and TESA 7476. The test specimens of the multilayer item (adhesive in contact with the silicone surface) were kept for 1 day at 23° C., 1 day at 70° C., and 7 days at 40° C. under the pressure conditions required according to the FINAT 10 test, then tested at low peeling speed according to the FINAT 3 test (FTM 3) known to those skilled in the art (Release—Finat 3 in the tables), or at high peeling speed according to the FINAT 4 test at room temperature (RT) or at 40° C. (Release—Finat 4).

The release force is expressed in cN/inch and is measured using a dynamometer, after pressurization of the samples either at room temperature (23° C.) or at higher temperature for accelerated aging tests (generally 70° C.).

Noise-zippy release: Perception of release concerning the force oscillation parameter: noisy, zippy (as opposed to “smooth”). Silent, jerk-free separation is desired.

The test results are presented in the tables below.

TABLE 4

| | Comp. | Comp. | Comp. | | |
|---|---|---|---|---|---|
| Compound | Ex. 1 | Ex. 2 | Ex. 3 | Ex. 1 | Ex. 2 |
| Smear | A | A | A | B | B |
| Rub-off | 10 | 10 | 10 | 10 | 10 |
| Subsequent | 98 | 100 | 100 | 100 | 100 |
| adhesion | | | | | |
| (%) FINAT | | | | | |
| 11 | | | | | |
| Release- | 12 | 208 | 12 | 32 | 32 |
| FINAT 3 | | | | | |
| 1 d-23° C. | | | | | |
| (TESA 7475) | | | | | |
| Release- | 14 | 247 | 13 | 37 | 42 |
| FINAT 3 | | | | | |
| 1 d-70° C. | | | | | |
| (TESA 7475) | | | | | |
| Release- | 11 | 243 | 15 | 122 | 178 |
| FINAT 3 | | | | | |
| 7 d-40° C. | | | | | |
| (TESA 7475) | | | | | |
| Release- | — | 207 | — | 32 | 31.9 |
| FINAT 4 | | | | | |
| 0.3 m/min | | | | | |
| Release- | — | 61 | | 68 | 64 |
| FINAT 4 | | | | | |
| 10 m/min | | | | | |
| Release- | — | 15 | — | 40 | 69.15 |
| FINAT 4 | | | | | |
| 50 m/min | | | | | |
| Release- | — | 7 | — | 57 | 55.3 |
| FINAT 4 | | | | | |
| 150 m/min | | | | | |
| Noise-zippy | — | loud | — | quiet | quiet |
| release | | cracking | | | |
| TESA 7475 | | sound | | | |

The results in Table 4 show that the compositions according to the invention comprising a resin B comprising Si—OH groups (examples 1-2) are more stable in terms of high speed pulling and give better results in terms of less noise-zippy release than the comparative composition without resin (comp. ex. 2). These results also show that the addition of a resin B comprising Si—OH groups makes it possible to control the release forces of the coating obtained. Indeed, it is observed that the release forces measured according to the FINAT 3 test after 1 day at 23° C. are comparable for the compositions without resin, whether or not they comprise an organic compound comprising an acrylate functional group (comp. ex. 1 and 3), whereas the measured release forces are greater for the compositions according to the invention comprising a resin B comprising Si—OH groups (ex. 1-2). Furthermore, the other evaluated properties of smear, rub-off, and subsequent adhesion remain satisfactory for the compositions according to the invention.

TABLE 5

| | Comp. | | | | | |
|---|---|---|---|---|---|---|
| Compound | Ex. 2 | Ex. 3 | Ex. 4 | Ex. 5 | Ex. 6 | Ex. 16 |
| Smear | A | A | A | A | A | A |
| Rub-off | 10 | 10 | 10 | 10 | 10 | 10 |
| Subsequent | 100 | 100 | 98 | 97 | 95 | |
| adhesion (%) | | | | | | |
| FINAT 11 | | | | | | |
| Release- | 208 | 46 | 43 | 32 | 17 | |
| FINAT 3 | | | | | | |
| 1 d-23° C. | | | | | | |
| (TESA 7475) | | | | | | |
| Release- | 247 | 47 | 46 | 50 | 25 | |
| FINAT 3 | | | | | | |
| 1 d-70° C. | | | | | | |
| (TESA 7475) | | | | | | |
| Release- | 243 | 53 | 47 | 43 | 25 | |
| FINAT 3 | | | | | | |
| 7 d-40° C. | | | | | | |
| (TESA 7475) | | | | | | |
| Release - | 207 | 46 | 45 | 32 | 17 | |
| FINAT 4 | | | | | | |
| 0.3 m/min | | | | | | |
| Release - | 161 | 53 | 46 | 144 | 32 | 104.05 |
| FINAT 4 | | | | | | |
| (TA) | | | | | | |
| 10 m/min | | | | | | |
| Release - | | | | | | 104.7 |
| FINAT 4 | | | | | | |
| (40° C.) | | | | | | |
| 10 m/min | | | | | | |
| Release - | 15 | 36 | 31 | 36 | 35 | |
| FINAT 4 | | | | | | |
| 50 m/min | | | | | | |
| Release - | 7 | 24 | 23 | 28 | 28 | |
| FINAT 4 | | | | | | |
| 150 m/min | | | | | | |
| Noise-zippy | loud | quiet | quiet | quiet | quiet | quiet |
| release | cracking | | | | | |
| TESA 7475 | sound | | | | | |

The results in Table 5 show that the compositions according to the invention comprising a resin B and an organic compound D comprising an acrylate functional group make it possible to obtain coatings having release forces which are stable after aging (examples 3 to 6 and 16). In addition, the compositions according to the invention are more stable in terms of pulling at high speed and give better results in terms of noise-zippy release than the comparative composition without resin (comp. ex. 2). Furthermore, it is also possible to control the release forces of the coating obtained, as a function of the resins used (examples 4 to 6). These results also show that it is possible to use several organopolysiloxanes A with different acrylate content.

TABLE 6

| | Comp. | Comp. | | | | | |
|---|---|---|---|---|---|---|---|
| Compound | Ex.1 | Ex. 2 | Ex. 7 | Ex. 8 | Ex. 9 | Ex. 10 | Ex. 11 |
| Smear | A | A | A | A | A | A | A |
| Rub-off | 10 | 10 | 10 | 10 | 10 | 10 | 10 |
| Subsequent | 98 | 100 | 100 | 100 | 100 | 100 | 90 |
| adhesion (%) | | | | | | | |
| Release- | 12 | 208 | 87 | 58 | 47 | 36 | 85 |
| FINAT 3 | | | | | | | |
| 1 d-23° C. | | | | | | | |
| (TESA 7475) | | | | | | | |
| Release- | 14 | 247 | 90 | 64 | 51 | 38 | — |
| FINAT 3 | | | | | | | |
| 1 d-70° C. | | | | | | | |
| (TESA 7475) | | | | | | | |
| Release- | 11 | 243 | 99 | 64 | 51 | 37 | — |
| FINAT 3 | | | | | | | |
| 7 d-40° C. | | | | | | | |
| (TESA 7475) | | | | | | | |
| Release- | 30 | 123 | 188 | 125 | 104 | 77 | — |
| FINAT 3 | | | | | | | |
| 1 d-23° C. | | | | | | | |
| (TESA 7476) | | | | | | | |
| Release- | 47 | 161 | 225 | 186 | 148 | 119 | — |
| FINAT 3 | | | | | | | |
| 1 d-70° C. | | | | | | | |
| (TESA 7476) | | | | | | | |
| Release- | 37 | 150 | 219 | 178 | 145 | 113 | — |
| FINAT 3 | | | | | | | |
| 7 d-40° C. | | | | | | | |
| (TESA 7476) | | | | | | | |
| Release - | — | 207 | 87 | — | — | — | — |
| FINAT 4 | | | | | | | |
| 0.3 m/min | | | | | | | |
| Release - | — | 61 | 60 | — | — | — | — |
| FINAT 4 | | | | | | | |
| 10 m/min | | | | | | | |
| Release - | — | 15 | 49 | — | — | — | — |
| FINAT 4 | | | | | | | |
| 50 m/min | | | | | | | |
| Release - | — | 7 | 29 | — | — | — | — |
| FINAT 4 | | | | | | | |
| 150 m/min | | | | | | | |
| Noise-zippy | — | loud | quiet | quiet | quiet | quiet | — |
| release | | cracking | | | | | |
| TESA 7475 | | sound | | | | | |
| Noise-zippy | — | loud | slight | slight | slight | slight | — |
| release | | cracking | cracking | cracking | cracking | cracking | |
| TESA 7476 | | sound | sound | sound | sound | sound | |

The results in Table 6 show that the compositions according to the invention (examples 7 to 10) allow obtaining coatings which have release forces that are as stable after aging as the compositions without resin (comparative example 1-2). In addition, these results show that it is possible to modify the release forces of the coating obtained by modifying the resin content in the composition (examples 7 to 10), and that it is possible to use different radical photoinitiators C (examples 10 and 11). Finally, the compositions according to the invention give better results in terms of noise-zippy release than the comparative composition without resin (comp. example 2).

TABLE 7

| | Comp. | Comp. | | | | |
|---|---|---|---|---|---|---|
| Compound | Ex. 1 | Ex. 2 | Ex. 12 | Ex. 13 | Ex. 14 | Ex. 15 |
| Smear | A | A | A | A | A | A |
| Rub-off | 10 | 10 | 10 | 10 | 10 | 10 |
| Subsequent | 98 | 100 | 92 | 97 | 97 | 95 |
| adhesion (%) | | | | | | |
| Release- | 12 | 208 | 55 | 135 | 39 | 100 |
| FINAT 3 | | | | | | |
| 1 d-23° C. | | | | | | |
| (TESA 7475) | | | | | | |
| Release- | 14 | 247 | 55 | 134 | 45 | 106 |
| FINAT 3 | | | | | | |
| 1 d-70° C. | | | | | | |
| (TESA 7475) | | | | | | |
| Release- | 11 | 243 | 59 | 158 | 45 | 115 |
| FINAT 3 | | | | | | |
| 7 d-40° C. | | | | | | |
| (TESA 7475) | | | | | | |
| Noise-zippy | — | loud | quiet | quiet | quiet | quiet |
| release | | cracking | | | | |
| TESA 7475 | | sound | | | | |
| Noise-zippy | — | loud | quiet | slight | quiet | slight |
| release | | cracking | | cracking | | cracking |
| TESA 7476 | | sound | | sound | | sound |

The results in Table 7 show that it is possible to modify the release forces of the coating obtained by modifying the resin content in the composition (examples 12-13 and 14-15), and by modifying the amount of acrylate having a low acrylate molar content (compound A2, see examples 12-13 vs. 14-15). In addition, the compositions according to the invention give better results in terms of zippy release than the comparative composition without resin (comp. ex. 2).

1. Radiation-curable silicone composition X comprising:
a. at least one organopolysiloxane A including at least one (meth)acrylate group; said organopolysiloxane A corresponding to the following formula (III): 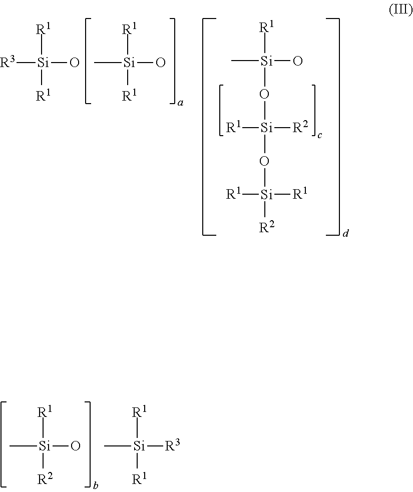
a formula in which:
the R¹ symbols, which are identical or different, each represent a linear or branched C₁ to C₁₈ alkyl group, a C₆ to C₁₂ aryl or aralkyl group, said alkyl and aryl groups possibly being substituted, preferably by halogen atoms, or an —OR⁵ group with R⁵ being a hydrogen atom ora hydrocarbon group comprising from 1 to 10 carbon atoms,
the R² and R³ symbols, which are identical or different, each represent either an R¹ group or a monovalent group of formula Z=-y-(Y′)n in which:
y represents a polyvalent C1-C18 alkylene or heteroalkylene group, said alkylene and heteroalkylene groups able to be linear or branched, and possibly being interrupted by one or more cycloalkylene groups, and possibly being extended by C1 to C4 oxyalkylene or polyoxyalkylene bivalent radicals, said alkylene, heteroalkylene, oxyalkylene, and polyoxyalkylene groups optionally being substituted by one or more hydroxy groups,
Y′ represents a monovalent alkenylcarbonyloxy group, and
n is equal to 1, 2, or 3, and
with a=0 to 500, b=0 to 500, c=0 to 500, d=0 to 500, and a+b+c+d=0 to 500, and
the condition that at least one R² or R³ symbol represents the monovalent group of formula Z, preferably at least two R² or R³ symbols represent a monovalent group of formula Z;
b. at least 25% by weight of an organopolysiloxane resin B comprising Si—OH groups; and
c. optionally, at least one radical photoinitiator C.

2. Silicone composition X according to claim 1, wherein it is curable by electron or photon irradiation, preferably by exposure to an electron beam, by exposure to gamma rays, or by exposure to radiation having a wavelength of between 200 nm and 450 nm, in particular UV radiation.

3. Silicone composition X according to claim 1, wherein the organopolysiloxane A has a molar content of (meth)acrylate functional group that is greater than or equal to 30 mmol/900 g of organopolysiloxane A, preferably between 35 and 250 mmol/100 g of organopolysiloxane A.

4. Silicone composition X according to claim 1, wherein the organopolysiloxane A comprises:
a1. at least one organopolysiloxane A1 including at least one (meth)acrylate group, and having a molar content of (meth)acrylate functional group that is greater than or equal to 30 mmol/100 g of organopolysiloxane A1, preferably between 35 and 250 mmol/100 g of organopolysiloxane A1; and
a2. at least one organopolysiloxane A2 including at least one (meth)acrylate group, and having a molar content of (meth)acrylate functional group that is less than 30 mmol/100 g of organopolysiloxane A2, preferably between 1 and 30 mmol/100 g of organopolysiloxane A2, and even more preferably between 15 and 25 mmol/100 g of organopolysiloxane A2.

5. Silicone composition X according to claim 4, wherein it comprises between 0.1 and 10% by weight of organopolysiloxane A2, preferably between 1 and 8% by weight.

6. Silicone composition X according to claim 1, wherein it comprises between 25 and 60% by weight of resin B.

7. Silicone composition X according to claim 1, wherein resin B has an OH functional group content comprised between 0.2 and 5% by weight, preferably between 0.5 and 5% by weight, more preferably between 0.6 and 4.5% by weight, and even more preferably between 0.7 and 4% by weight.

8. Silicone composition X according to claim 1, wherein resin B is an MDT resin or an MQ resin.

9. Silicone composition X according to claim 1, wherein it further comprises an organic compound D comprising at least one (meth)acrylate functional group.

10. Use of the silicone composition X according to claim 1, for the preparation of silicone elastomers capable of being used as a release coating on a substrate.

11. Method for preparing a coating on a substrate, comprising the following steps:
applying a silicone composition X according to claim 1, onto a substrate, and
curing said composition by electron or photon irradiation, preferably by exposure to an electron beam, by exposure to gamma rays, or by exposure to radiation having a wavelength of between 200 nm and 450 nm, in particular UV radiation.

12. Method according to claim 11, wherein the substrate is a flexible substrate made of textile, paper, polyvinyl chloride, polyester, polypropylene, polyamide, polyethylene, polyethylene terephthalate, polyurethane, or non-woven fiberglass.

13. Coated substrate obtainable by the method according to claim 11.

14. Premix for a silicone composition, comprising:
a. between 20 and 40% by weight of at least one organopolysiloxane A including at least one (meth)acrylate group;
b. between 30 and 50% by weight of an organopolysiloxane resin B comprising Si—OH groups; and
c. between 10 and 30% by weight of an organic compound D comprising a (meth)acrylate functional group.
